(19) United States
(12) Patent Application Publication
(10) Pub. No.: US 2018/0118993 A1
(43) Pub. Date: May 3, 2018

(54) RESERVOIR PROTECTING AGENT COMPOSITION FOR RESERVOIR WITH CRACKS, DRILLING FLUID CONTAINING THE SAME AND USE THEREOF

(71) Applicant: China University of Petroleum (East China), Qingdao (CN)

(72) Inventors: Kaihe LV, Qingdao (CN); Jinsheng SUN, Qingdao (CN); Jingping LIU, Qingdao (CN)

(73) Assignee: China University of Petroleum (East China), Qingdao (CN)

(21) Appl. No.: 15/400,672

(22) Filed: Jan. 6, 2017

(30) Foreign Application Priority Data
Oct. 31, 2016 (CN) 201610931555.7

(51) Int. Cl. C09K 8/24; E21B 21/00; E21B 33/138

(52) U.S. Cl. CPC C09K 8/24; C09K 2208/08; E21B 33/138; E21B 21/003

(57) ABSTRACT

The present invention relates to the technical field of petroleum drilling, discloses a reservoir protecting agent composition for reservoir with cracks, a drilling fluid containing the same and use thereof. The reservoir protecting agent composition contains an elastic polymer particle, and at least one of a synthetic fiber and a film-forming agent; the elastic polymer particle contains an intermediate product, base, salt and water with specific amounts; and the intermediate product is made of raw materials comprising acrylamide, a cationic monomer, a cross-linking agent, an initiator, a toughening material and water with specific amounts. The reservoir protecting agent composition of the present invention can effectively prevent the drilling fluid from invading the reservoir with cracks, and rapidly block off cracks in the reservoir with cracks. The reservoir protecting agent composition has a high blocking rate and the blocking layer is easily flowback and has advantages such as easy use, good environmental protection performances, and good protection performances for the reservoir.

### CROSS REFERENCE TO RELATED APPLICATIONS

This application claims priority to Chinese Application No. 201610931555.7 filed on Oct. 31, 2016 entitled “Reservoir protecting agent composition, a drilling fluid containing the reservoir protecting agent composition and use thereof,” the content of which is hereby incorporated by reference as if recited in its entirety.

### FIELD

The present invention relates to the technical field of petroleum drilling, specifically, relates to a reservoir protecting agent composition for reservoir with cracks, a drilling fluid containing the reservoir protecting agent composition and use thereof.

### BACKGROUND

The drilling fluid plays an important role during the process of drilling well. The performances of the drilling fluid determine whether the well drilling is succeeded at a certain degree. Good drilling fluid performances are one of important ensuring measures to ensure safe, high quality, high efficient, and rapid production and operations for drilling well. Meanwhile, they can also effectively perform protection for the reservoir, to achieve high oil gas recovery rate. During the process of drilling well, if the performances of the drilling fluid, in particular, the performance for protecting the reservoir, are unsatisfactory, it would lead to invasion of the fluid and solid in the drilling fluid into the reservoir, which reduces the reservoir permeability around the well hole, and increases the resistance of the oil gas to flow to the bottom of the well, thereby reducing the output of the crude oil.

It is a rising trend for the reservoir with cracks to occupy the ratio of the mining, and the cracks become good permeating and flowing channels that are communicated with a well cylinder. However, when the drill meets a crack-oil deposit reservoir, under the action of the pressure difference, the drilling fluid would invade the reservoir along the cracks, causing the cracks to be jammed. Until now, at home and abroad, exploring in the aspect of the drilling fluid technique for protecting the reservoir with cracks has been done for a long period of time, and the materials for protecting the reservoir with cracks are developed. The current materials for protecting the reservoir with cracks are generally a combination of various types of materials, in which, substances such as rigid particles (such as calcium carbonate), fiber and/or pitch are normally contained. By means of compounds of these components, the functions of blocking the cracks and preventing the drilling fluid from invading are achieved. However, the mechanism for the protective materials to protect the reservoir is still the temporary shielding function.

The temporary shielding technique has the following problems: firstly, to generate a good temporary shielding function, the widths and distribution characteristics of the reservoir cracks must be accurately known. Due to the inhomogeneity characteristics of the reservoir, the characteristics of the reservoir cracks are hard to be mastered, so that the temporary shielding effect is unsatisfactory; secondly, the temporary shielding material requires to enter inside the cracks to generate blocking, and the blocking layer, while preventing the drilling fluid from entering the reservoir, also prevents the oil gas from flowing into the well hole. Therefore, jam removal is necessarily required after the well is drilled. Meanwhile, the current protective materials lack components having good elasticity and tenacity, and have unsatisfactory effects for protecting the reservoir with cracks. Therefore, it is urgently in need of developing a novel reservoir protecting agent that is suitable for the reservoir with cracks, and is strong in blocking, and easy in flowback.

### SUMMARY

The general inventive concepts are directed to overcoming the aforementioned defects existing in the prior art of protecting a reservoir with cracks, providing a reservoir protecting agent composition for reservoir with cracks, a drilling fluid containing the reservoir protecting agent composition and use thereof. The reservoir protecting agent composition of the present invention has a rapid blocking speed, a wide blocking range, and a good blocking effect, and blocks in a single direction without blocking removal operations, wherein the blocking is easily flowback and removed, so that the dependence on the width of the reservoir cracks is weak; the composition is adapted to protecting the reservoir during the process of drilling well, in particular, to protecting the reservoir in the reservoir with cracks, and can improve the ability of the drilling fluid to protect the reservoir, and enhance the ability of the drilling fluid to stabilize the well walls.

In order to achieve the aforementioned purposes, in a first aspect, the present invention provides a reservoir protecting agent composition, wherein the reservoir protecting agent composition contains an elastic polymer particle, and at least one of a synthetic fiber and a film-forming agent, wherein the elastic polymer particle comprises an intermediate product, base, salt and water, and based on 100 parts by weight of the elastic polymer particle, the intermediate product is present in 5-40 parts by weight, the base is present in 1-10 parts by weight, and the salt is present in 1-12 parts by weight, and wherein the intermediate product is prepared by raw materials comprising acrylamide, a cationic monomer, a cross-linking agent, an initiator, a toughening material and water, and based on 100 parts by weight of the raw materials, the acrylamide is present in 8-30 parts by weight, the cationic monomer is present in 1-10 parts by weight, the cross-linking agent is present in 0.01-0.5 parts by weight, the initiator is present in 0.01-0.1 parts by weight, and the toughening material is present in 5-25 parts by weight.

In a second aspect, the present invention provides a drilling fluid, and the drilling fluid contains the reservoir protecting agent composition of the present invention.

In a third aspect, the present invention provides a use of the reservoir protecting agent composition of the present invention or the drilling fluid of the present invention in drilling well of a reservoir section.

The reservoir protecting agent composition of the present invention can effectively prevent the drilling fluid from invading the reservoir, is adapted to protect the reservoir (including the reservoir with cracks and the reservoir with pores) during the process of drilling well, and in particular, is adapted to the reservoir with cracks. It can rapidly block the cracks in the reservoir with cracks, the blocking rate is high, the flowback of the blocking layer is easy, and it has advantages such as easy use, good environmental protection performances, and good protection performances for the reservoir. Moreover, the reservoir protecting agent composition of the present invention can be added into a drilling fluid system with any constituents according to requirements, and in addition to improving the capability of the drilling fluid to protect the reservoir, it can also enhance the capability of the drilling fluid to stabilize well walls, and has no bad influence on other performances of the drilling fluid.

Taking the protection of the reservoir in the reservoir with cracks as an example, in the reservoir protecting agent composition of the present invention, the elastic polymer particle has the following remarkable advantages:

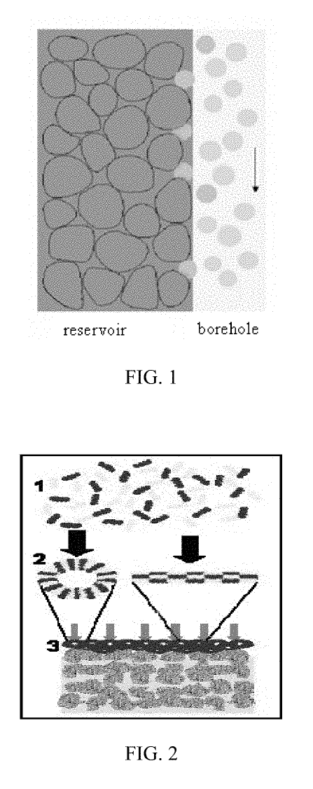

(1) Rapid blocking speed and high blocking success rate are provided. The elastic polymer particle is irregularly-shaped, deformable, and difficult-to-be-damaged elastic particle, has better elasticity and tenacity. When the diameter of the elastic polymer particle is larger than the width of the reservoir crack (the diameter of the elastic polymer particle is required to be larger than the width of the reservoir cracks, and the elastic polymer particle of corresponding granularity can be prepared according to actual using conditions), under the action of the pressure difference, the elastic particle can be partially inserted into an entrance of the crack, to block the crack, and the remaining part is still located outside the crack to function for blocking (see FIG. 1). Meanwhile, the elastic polymer particle has good adaptability for the cracks with different shapes of entrances, overcome the defect of the rigid particles with weak adaptability due to lack of deformation, and can rapidly generate blocking in the cracks thereby achieving the purpose of stopping the drilling fluid from continuously invading the reservoir.

(2) Unidirectional blocking is provided without blocking removal operations. The elastic polymer particle is inserted at the entrance of the crack without entering inside the crack, and if a back pressure difference exists, the inserted blocking layer would be easily removed. Therefore, using the elastic polymer particle does not require a special jam removal measure. After well completion, under the action of production pressure difference (negative pressure difference), the jam is automatically removed, and the reservoir is recovered to the original permeability, without influencing the oil well capacity and without the blocking removal operations.

(3) The applicable temperature and degree of mineralization have wide ranges. The elastic polymer particle stably exists at a temperature range between the room temperature to 200° C. temperature, has a higher thermal stability, and can be applied to reservoir with different well depths. The elastic polymer particle is subjected to few influences from the degree of mineralization, and can be applied to the saline water drilling fluid with hypersalinity.

In the reservoir protecting agent composition of the present invention, the main ingredient of the film-forming agent is a micella polymer. When a critical concentration is reached, association occurs to the micella polymer to form a large amount of micella in different sizes. The core of the micella consists of hydrophobic groups of the micella polymer, and an outer layer consists of hydrophilic sections of the micella polymer. Under the action of the pressure difference, the micella gathers on the surface of the rock to form a shielding film (see FIG. 2), to stop the drilling fluid from invading the reservoir. It can be seen from FIG. 2 that the shielding film formed by the film-forming agent is only located at the surface of the rock of the well walls without entering inside the rock. If a back pressure difference exists, the blocking function would be automatically removed, and the reservoir is recovered to the original permeability, without influencing the oil well capacity.

In the reservoir protecting agent composition of the present invention, the particles of the synthetic fiber are flexible, and have a great ratio of length to diameter. They exist in the drilling fluid normally in the shape of clusters. If the size of the cluster-shaped particle group is larger than the width of the crack, the cluster-shaped particle group would generate blocking at the entrance of the crack. Since the cluster-shaped particle group has multiple contact points with the rock at the entrance of the crack, the cluster-shaped particle group is tightly attached at the entrance of the crack, to form a bridging fiber network, which effectively prevents the drilling fluid from invading the reservoir. Since the blocking is also at the entrance of the crack, without entering inside of the crack, and has a deformable characteristic, the blocking thereof can be more easily to be removed as compared with the rigid particle, and has a characteristic of unidirectional blocking.

In conclusion, in the reservoir protecting agent composition of the present invention, the elastic polymer particle and at least one of the synthetic fiber and the film-forming agent can achieve a synergistic effect together. According to a preferable embodiment of the present invention, three ingredients, i.e., the elastic polymer particle, the synthetic fiber and the film-forming agent can better achieve the synergistic effect. First, the elastic polymer particle and synthetic fiber block the cracks of larger sizes, and reduce the sizes of the cracks. On this basis, the film-forming agent forms a shielding film of the polymer micella on the surface of the rock of the well walls, and by means of the composite action of “bridging, and shielding/inserting and shielding-film shielding,” the effect of protection the reservoir using multiple functions with synergistic interaction is achieved.

The reservoir protecting agent composition of the present invention is in particular adapted to protecting the reservoir with cracks, the characteristics for protecting the reservoir are as follows:

(1) The protective layer formed by the reservoir protecting agent composition of the present invention is mainly located at the surface of the well walls or the entrance of the crack rather than inside the reservoir crack. Therefore, using the reservoir protecting agent composition of the present invention does not require additional blocking removal operations, and only a back pressure difference is required to be generated at the bottom of the well after well completion, the blocking can be eliminated.

(2) With respect to the current temporary shielding technique commonly used, the reservoir protecting agent composition of the present invention has better adaptability. The temporary shielding technique requires the calcium carbonate or other rigid particles to enter inside of the cracks for bridging. The sizes of the particles for bridging are necessarily strictly matched with the widths of the cracks, or the bridging would not generate effective blocking. Due to anisotropy characteristics of the reservoir, it is normally hard to accurately master the distribution of the width sizes of the reservoir cracks. In this case, selecting the size of the particle for bridging has a relatively great blindness, and the temporary shielding effect is normally not good. Moreover, the reservoir protecting agent composition of the present invention requires the size of the elastic polymer particle to be larger than the widths of the cracks. In the case of unknowing the distribution of the sizes of the reservoir cracks, particles of larger sizes may be selected to ensure to insert the temporary shielding effect. The shielding film formed by the film-forming agent polymer micella also has better adaptability, and has a broad spectrum blocking performance for the cracks after being blocked by the elastic polymer particles and the synthetic fiber. Therefore, in the case of knowing or unknowing the distribution of the sizes of the reservoir cracks, the reservoir protecting agent composition of the present invention has a good blocking effect, while the current temporary shielding technique is only well applied in the case of knowing the distribution of the sizes of the reservoir cracks.

Other characteristics and advantages of the general inventive concepts will be explained in the following part of detailed description of the embodiments in greater detail.

### BRIEF DESCRIPTION

The drawings are used for providing further understanding of the present invention, and constituting a part of the description, and are used together with the following detailed description of the embodiments to explain the present invention, but do not used as limits to the present invention. In the drawings:

FIG. 1 is a schematic diagram of inserting and blocking by the elastic polymer particle in the reservoir protecting agent composition of the present invention.

FIG. 2 is a schematic diagram of shielding by the film-forming agent in the reservoir protecting agent composition of the present invention, wherein 1 is a film-forming agent, 2 is a film-forming agent micella, and 3 is a low permeability shielding film formed by the film-forming agent micella.

### DETAILED DESCRIPTION

Hereunder some embodiments of the general inventive concepts will be detailed. It should be appreciated that the embodiments described here are only provided to describe and explain the present invention but shall not be deemed as constituting any limitation to the present invention.

The endpoint values and any value in the ranges disclosed in the present invention are not limited to the exact ranges or values. Instead those ranges or values shall be comprehended as encompassing values that are close to those ranges or values. For numeric ranges, between the endpoint values of the ranges, between the endpoint values of the ranges and the individual point values, and between the individual point values can be combined to obtain one or more new numeric ranges which shall be deemed as having been disclosed specifically in this document.

In a first aspect, the present invention provides a reservoir protecting agent composition, wherein the reservoir protecting agent composition contains a elastic polymer particle, and at least one of a synthetic fiber and a film-forming agent, wherein the elastic polymer particle comprises an intermediate product, base, salt and water, and based on 100 parts by weight of the elastic polymer particle, the intermediate product is present in 5-40 parts by weight, the base is present in 1-10 parts by weight, and the salt is present in 1-12 parts by weight, and wherein the intermediate product is prepared by raw materials comprising acrylamide, a cationic monomer, a cross-linking agent, an initiator, a toughening material and water, and based on the raw materials of 100 parts by weight, the acrylamide is present in 8-30 parts by weight, the cationic monomer is present in 1-10 parts by weight, the cross-linking agent is present in 0.01-0.5 parts by weight, the initiator is present in 0.01-0.1 parts by weight, and the toughening material is present in 5-25 parts by weight.

In the reservoir protecting agent composition of the present invention, those skilled in the art should understand that, “the reservoir protecting agent composition contains a elastic polymer particle, and at least one of a synthetic fiber and a film-forming agent” refers to that the reservoir protecting agent composition, in addition to containing the elastic polymer particle, further contains at least one of a synthetic fiber and a film-forming agent. That is, the reservoir protecting agent composition contains the elastic polymer particle and the synthetic fiber, or the reservoir protecting agent composition contains the elastic polymer particle and the film-forming agent, or the reservoir protecting agent composition contains the elastic polymer particle, the synthetic fiber and the film-forming agent.

In certain embodiments, the mass ratio of the elastic polymer particle and the synthetic fiber is 1:(0.1-1.5), and preferably is 1: (0.25-1).

In the reservoir protecting agent composition of the present invention, in order to further improve the ability of the drilling fluid to protect the reservoir, in a preferable case, the mass ratio of the elastic polymer particle and the film-forming agent is 1:(0.1-1.5), including 1: (0.25-1).

In certain embodiments, the reservoir protecting agent composition contains the elastic polymer particle, the synthetic fiber and the film-forming agent, and the mass ratio of the elastic polymer particle, the synthetic fiber and the film-forming agent is 1:(0.1-1.5):(0.1-1.5), including 1:(0.25-1):(0.25-1).

In the reservoir protecting agent composition of the present invention, to facilitate usage, in a preferable case, the elastic polymer particle, the synthetic fiber and the film-forming agent in the reservoir protecting agent composition are individually packaged, respectively.

In the reservoir protecting agent composition of the present invention, no special limit to the synthetic fiber exists, and it can be various synthetic fibers commonly used in the art. In a preferable case, the synthetic fiber is at least one of polyester fiber, polyamide fiber, polyacrylonitrile fiber, polyvinyl alcohol fiber, polyvinyl formal fiber and polyurethane elastic fiber.

In the reservoir protecting agent composition of the present invention, no special limit to the film-forming agent exists, and it can be various film-forming agents commonly used in the art. In a preferable case, the film-forming agent is at least one of ultra-low permeable drilling fluid treating agent, zero osmosis drilling fluid treating agent (or a non-osmosis drilling fluid treating agent) and other products having similar functions.

In the reservoir protecting agent composition of the present invention, in order to further improve the ability of the drilling fluid to protect the reservoir, in a preferable case, based on 100 parts by weight of the raw materials for preparing the intermediate product, the acrylamide is present in 10-25 parts by weight, the cationic monomer is present in 2-5 parts by weight, the cross-linking agent is present in 0.01-0.05 parts by weight, the initiator is present in 0.02-0.05 parts by weight, and the toughening material is present in 8-15 parts by weight. Those skilled in the art should understand that, in the raw materials for preparing the intermediate product, the amount of water meets the condition that the parts by weight of all components constituting the raw materials have a sum of 100.

In the reservoir protecting agent composition of the present invention, in a preferable case, the cationic monomer is quaternary ammonium compound, and further preferably is at least one of dimethyl diallyl ammonium halide (such as dimethyl diallyl ammonium chloride, and dimethyl diallyl ammonium bromide), methacryloyloxyethyl trimethyl ammonium halide (such as methacryloyloxyethyl trimethyl ammonium chloride, and methacryloyloxyethyl trimethyl ammonium bromide), acryloyloxyethyl trimethyl ammonium halide (such as acryloyloxyethyl trimethyl ammonium chloride, and acryloyloxyethyl trimethyl ammonium bromide), alkyl dimethyl benzyl ammonium halide, and alkyl trimethyl ammonium halide, and further preferably, the alkyl in the alkyl dimethyl benzyl ammonium halide is alkyl of C₈-C₂₀ (such as dodecyl dimethyl benzyl ammonium chloride, hexadecyl dimethyl benzyl ammonium bromide, and octadecyl dimethyl benzyl ammonium chloride), and the alkyl in the alkyl trimethyl ammonium halide is alkyl of C₈-C₂₀ (such as dodecyl trimethyl ammonium chloride, hexadecyl trimethyl ammonium bromide, and octadecyl trimethyl ammonium chloride).

In the reservoir protecting agent composition of the present invention, no special limit to the cross-linking agent exists, and it can be various cross-linking agents commonly used in the art. In a preferable case, the cross-linking agent is at least one of N,N′-methylene bis-acrylamide, divinyl benzene and glutaraldehyde.

In the reservoir protecting agent composition of the present invention, no special limit to the initiator exists, and it can be various initiators commonly used in the art. In a preferable case, the initiator is persulfate, and more preferably, is at least one of ammonium persulfate, potassium persulfate and sodium persulfate.

In the reservoir protecting agent composition of the present invention, no special limit to the toughening material exists, and it can be various toughening materials commonly used in the art. In a preferable case, the toughening material is starch and/or bentonite.

In the reservoir protecting agent composition of the present invention, a method for preparing the intermediate product may comprise: mixing the acrylamide, the cationic monomer, the cross-linking agent, the toughening material and the water, adding the initiator into the obtained mixture for reaction, and then drying and smashing the reaction product.

In a preferable case, the method of mixing the acrylamide, the cationic monomer, the cross-linking agent, the toughening material and the water includes: (1) adding the acrylamide, the cationic monomer and the cross-linking agent into water for dissolving, and stirring evenly; (2) adding the toughening material into the mixture of step (1), and stirring evenly; and (3) stirring the mixture of step (2) under the protective atmosphere, wherein the protective atmosphere may be nitrogen and/or inert gas, and the stirring time in step (3) may be 20-30 min.

In a preferable case, the reaction condition includes: the temperature is 30-60° C., the time is 3-5 h, and the introduce of the protective atmosphere and stirring can be stopped after the reaction.

In a preferable case, the drying condition includes: the temperature is 50-150° C., and the time is 10-24 h.

In the present invention, there is no special limit on the size of the granularity of the product obtained through smashing. The diameter of the elastic polymer particle made from the product obtained through smashing should be larger than the width of the reservoir cracks according to an applicative width of the reservoir cracks.

In certain embodiments, based on 100 parts by weight of the elastic polymer particle, the intermediate product is present in 10-30 parts by weight, the base is present in 2-5 parts by weight, and the salt is present in 5-10 parts by weight. Those skilled in the art should understand that in the previous elastic polymer particle, the amount of water meets the condition that the parts by weight of all components constituting the elastic polymer particle have a sum of 100.

In the elastic polymer particle of the reservoir protecting agent composition of the present invention, no special limit to the base exists, and it can be various bases commonly used in the art. In a preferable case, the base is at least one of sodium hydrate, potassium hydroxide, sodium carbonate, potassium carbonate, sodium bicarbonate and potassium bicarbonate.

In the elastic polymer particle of the reservoir protecting agent composition of the present invention, no special limit to the salt exists, and it can be various salts commonly used in the art. In a preferable case, the salt is at least one of sodium chloride, potassium chloride, calcium chloride, sodium formate, potassium formate and cesium formate.

In the elastic polymer particle of the reservoir protecting agent composition of the present invention, in a preferable case, the elastic polymer particle further includes bactericide, and based on 100 parts by weight of the elastic polymer particle, the bactericide is 0.03-2 parts by weight, and preferably is present in 0.05-1 parts by weight.

In a preferable case, the bactericide is adsorptive bactericide, and further preferably is at least one of alkyl trimethyl ammonium halide, alkyl halogenated pyridine and alkyl dimethyl benzyl ammonium halide. More further preferably, the alkyl in the alkyl trimethyl ammonium halide is alkyl of C₈-C₂₀ (such as dodecyl trimethyl ammonium chloride, hexadecyl trimethyl ammonium bromide, and octadecyl trimethyl ammonium chloride), the alkyl in the alkyl halogenated pyridine is alkyl of C₈-C₂₀ (such as dodecylpyridinium chloride, hexadecylpyridinium chloride, and octadecylpyridinium bromide), and the alkyl in the alkyl dimethyl benzyl ammonium halide is alkyl of C₈-C₂₀ (such as dodecyl dimethyl benzyl ammonium chloride, hexadecyl dimethyl benzyl ammonium bromide, and octadecyl dimethyl benzyl ammonium chloride).

In the reservoir protecting agent composition of the present invention, the method for preparing the elastic polymer particle may include: mixing the intermediate product, the base, the salt, a selectable bactericide and the water.

In a preferable case, the mixing method comprises: first mixing the intermediate product, the base and the water (stirring for 5-20 h), and then mixing the obtained mixture with the salt and selectable bactericide (stirring for 0.5-2 h); or the mixing method comprises: first mixing the intermediate product, the base, a selectable bactericide and the water (stirring for 5-20 h), and then mixing the obtained mixture with the salt (stirring for 0.5-2 h). Those skilled in the art should understand that in the method for preparing the elastic polymer particle, the “selectable” bactericide refers to adding a corresponding amount of bactericide during preparation when the elastic polymer particle contains the bactericide, and when the elastic polymer particle does not contain the bactericide, there is no need to add a corresponding amount of bactericide during preparation.

In a second aspect, the present invention further provides a drilling fluid, the drilling fluid contains the reservoir protecting agent composition of the present invention. In a preferable case, in the drilling fluid, the content of the reservoir protecting agent composition of the present invention is 1-5% (the percentage is the ratio of mass to volume, i.e., based on the drilling fluid of 100 ml, the the reservoir protecting agent composition is present in an amount of 1-5 g). When using the reservoir protecting agent composition of the present invention, various corresponding components of the reservoir protecting agent composition can be added into the drilling fluid system, and there is no special limit to the orders for adding the various components. There is no special limit to the system of the drilling fluid containing the reservoir protecting agent composition of the present invention, and it can be conventionally various drilling fluid systems in the art. It is only required to add the reservoir protecting agent composition of the present invention to the conventional drilling fluid systems.

In a third aspect, the present invention provides a use of the reservoir protecting agent composition of the present invention or the drilling fluid of the present invention in drilling well of a reservoir section.

The reservoir of the present invention can relate to reservoir with cracks or reservoir with pores, and preferably, the reservoir relates to reservoir with cracks. That is, the reservoir protecting agent composition of the present invention and the drilling fluid containing the reservoir protecting agent composition of the present invention is in particular adapted to an application of blocking and protecting the reservoir in the reservoir with cracks during the process of drilling well.

### EXAMPLES

Hereunder the present invention will be detailed in some examples but it should be noted that the present invention are not limited to those examples. In the following preparation examples, examples and comparative examples unless otherwise specified all of the materials are commercially available and all of the methods are conventional method in the art.

Polyester fiber is commercially available from Shenzhen Tianzhitu Science and Technology Limited Company, with the shop sign to be TZT-PET-6.

Polyacrylonitrile fiber is commercially available from Shenzhen Tianzhitu Science and Technology Limited Company, with the shop sign to be TZT-PAN-6.

The zero osmosis drilling fluid treating agent is commercially available from Hebei Huayun Hongye Chemical Engineering Limited Company, with the shop sign to be HY-3000.

The ultra-low permeable drilling fluid treating agent is commercially available from Shijiazhuang Hualai Dingsheng Science and Technology Limited Company, with the shop sign to be YP-4.

### Preparation Example 1

The present preparation example is used to illustrate the method for preparing the elastic polymer particle.

Add 20 kg of acrylamide, 4 kg of dimethyl diallyl ammonium chloride and 0.01 kg of N,N′-methylene bis-acrylamide into 67.96 kg of water, fully dissolving, and then add 8 kg of bentonite, stirring evenly. Add the aforementioned reaction fluid in a reactor provided with a stirrer, a condenser pipe, and a thermometer, introduce nitrogen for protection, stir for 20 min, then adjust the temperature to 60° C., add 0.03 kg of ammonium persulfate, stop introducing nitrogen and stirring, and react for 3 h. Take out the reaction product, dry the same at 105° C. for 15 h, and smash the same to obtain the intermediate product of a reservoir protecting agent in a granulated shape.

Add 10 kg of the intermediate product and 5 kg of sodium carbonate into 79.95 kg of water, continuously stirring for 10 h, and then add 5 kg of sodium chloride and 0.05 kg of octadecyl trimethyl ammonium chloride, continuously stirring for 0.5 h, to obtain the elastic polymer particle A1.

### Preparation Example 2

The present preparation example is used to illustrate the method for preparing the elastic polymer particle.

Add 25 kg of acrylamide, 5 kg of methacryloyloxyethyl trimethyl ammonium chloride and 0.02 kg of glutaraldehyde into 59.93 kg of water, fully dissolving, and then add 10 kg of starch, stirring evenly. Add the aforementioned reaction fluid in a reactor provided with a stirrer, a condenser pipe, and a thermometer, introduce nitrogen for protection, stir for 30 min, then adjust the temperature to 50° C., add 0.05 kg of potassium persulfate, stop introducing nitrogen and stirring, and react for 4 h. Take out the reaction product, dry the same at 110° C. for 12 h, and smash the same to obtain the intermediate product of a reservoir protecting agent in a granulated shape.

Add 20 kg of the intermediate product, 3 kg of potassium hydroxide, and 0.3 kg of hexadecylpyridinium chloride into 69.7 kg of water, continuously stirring for 10 h, and then add 7 kg of potassium chloride, continuously stirring for 1 h, to obtain the elastic polymer particle A2.

### Preparation Example 3

The present preparation example is used to illustrate the method for preparing the elastic polymer particle.

Add 10 kg of acrylamide, 2 kg of dodecyl dimethyl benzyl ammonium chloride and 0.05 kg of divinyl benzene into 72.93 kg of water, fully dissolving, and then add 15 kg of bentonite, stirring evenly. Add the aforementioned reaction fluid in a reactor provided with a stirrer, a condenser pipe, and a thermometer, introduce nitrogen for protection, stir for 25 min, then adjust the temperature to 40° C., add 0.02 kg of sodium persulfate, stop introducing nitrogen and stirring, and react for 5 h. Take out the reaction product, dry the same at 90° C. for 18 h, and smash the same to obtain the intermediate product of a reservoir protecting agent in a granulated shape.

Add 30 kg of the intermediate product and 2 kg of sodium hydrate into 57 kg of water, continuously stirring for 15 h, and then add 10 kg of sodium formate and 1 kg of dodecyl dimethyl benzyl ammonium chloride, continuously stirring for 0.5 h, to obtain the elastic polymer particle A3.

### Preparation Example 4

According to the method of preparation example 1, except that in the method for preparing the intermediate product, the amounts of the acrylamide, dimethyl diallyl ammonium chloride, N,N′-methylene bis-acrylamide, water, bentonite, and ammonium persulfate are respectively 8 kg, 8 kg, 0.5 kg, 78.49 kg, 5 kg, and 0.01 kg to obtain the elastic polymer particle A4.

### Preparation Example 5

According to the method of preparation example 1, except that the amounts of the intermediate product, sodium carbonate, water, sodium chloride, and octadecyl trimethyl ammonium chloride are respectively 6 kg, 1 kg, 88.5 kg, 3 kg, and 1.5 kg to obtain the elastic polymer particle A5.

### Examples 1-11

Prepare the drilling fluid according to the following formula: 3% of the reservoir protecting agent composition (see Table 1 for the components thereof, wherein the elastic polymer particle respectively used in examples 1-11 are A1, A2, A3, A1, A1, A1, A1, A4, A5, A1, and A1; and the synthetic fiber respectively used in examples 1 and 2 are polyester fiber and polyacrylonitrile fiber, the synthetic fiber respectively used in examples 3-11 are polyester fibers, the film-forming agents respectively used in examples 1 and 2 are the zero osmosis drilling fluid treating agent HY-3000 and ultra-low permeable drilling fluid treating agent YP-4, and the film-forming agents respectively used in examples 3-11 are zero osmosis drilling fluid treating agent HY-3000), 3% of sodium bentonite (commercially available from Anyang Yihe Bentonite Co., Ltd.), 0.5% of KPAM (commercially available from Potassium Polyacrylate of Shandong Yanggu Jiangbei Chemical Industry Co., Ltd.), 0.3% of PAC-HV (commercially available from Polyanionic Cellulose of Shandong Yanggu Jiangbei Chemical Industry Co., Ltd.), 0.2% of XY-27 (commercially available from Zwitterionic Polymer Viscosity Reducer of Shandong Deshunyuan Petroleum Sci.& Tech. Co. Ltd), 2.5% of SPNH (commercially available from Brown coal resin of Shandong Deshunyuan Petroleum Sci.& Tech. Co. Ltd), 2% of FF-I (commercially available from High Acid Soluble Sulfonated Asphalt of Shandong Deshunyuan Petroleum Sci.& Tech. Co. Ltd), 0.2% of KOH, and the rest being water. In the previous drilling fluid, each percentage is the ratio of mass to volume, for example, 3% of sodium bentonite refers to the amount of sodium bentonite in 100 ml of drilling fluid is 3 g.

### Comparative Example 1

According to the method of example 1, except that no reservoir protecting agent composition is added (see Table 1 for specific components), that is, prepare the drilling fluid according to the following formula: 3% of sodium bentonite (commercially available from Anyang Yihe Bentonite Co., Ltd.), 0.5% of KPAM (commercially available from Potassium Polyacrylate of Shandong Yanggu Jiangbei Chemical Industry Co., Ltd.), 0.3% of PAC-HV (commercially available from Polyanionic Cellulose of Shandong Yanggu Jiangbei Chemical Industry Co., Ltd.), 0.2% of XY-27 (commercially available from Zwitterionic Polymer Viscosity Reducer of Shandong Deshunyuan Petroleum Sci.& Tech. Co. Ltd), 2.5% of SPNH (commercially available from Brown coal resin of Shandong Deshunyuan Petroleum Sci.& Tech. Co. Ltd), 2% of FF-I (commercially available from High Acid Soluble Sulfonated Asphalt of Shandong Deshunyuan Petroleum Sci.& Tech. Co. Ltd), 0.2% of KOH, and the rest being water.

### Comparative Example 2

According to the method of example 1, except that use a zero osmosis drilling fluid treating agent HY-3000 to replace the reservoir protecting agent composition (see Table 1 for specific components), and in the drilling fluid, the content of the zero osmosis drilling fluid treating agent HY-3000 is 3%.

### Comparative Example 3

According to the method of example 1, except that use polyester fiber to replace the reservoir protecting agent composition (see Table 1 for specific components), and in the drilling fluid, the content of the polyester fiber is 3%.

### Comparative Example 4

According to the method of example 1, except that use the elastic polymer particle A1 to replace the reservoir protecting agent composition (see Table 1 for specific components), and in the drilling fluid, the content of the elastic polymer particle A1 is 3%.

### Comparative Example 5

According to the method of example 1, except that use the polyester fiber and zero osmosis drilling fluid treating agent HY-3000 to replace the reservoir protecting agent composition (see Table 1 for specific components), a mass ratio of the polyester fiber and zero osmosis drilling fluid treating agent HY-3000 is 1:1, and in the drilling fluid, a total content of the polyester fiber and zero osmosis drilling fluid treating agent HY-3000 is 3%.

TABLE 1

| | The mass ratio of the synthetic fiber, |
|---|---|
| | elastic polymer particle and film- |
| | forming agent in the drilling fluid |
| Example 1 | 0.25:1:0.25 |
| Example 2 | 0.33:1:0.67 |
| Example 3 | 0.67:1:0.33 |
| Example 4 | 1:1:0.5 |
| Example 5 | 0.33:1:0.33 |
| Example 6 | 0.5:1:1 |
| Example 7 | 1.5:1:1.5 |
| Example 8 | 0.25:1:0.25 |
| Example 9 | 0.25:1:0.25 |
| Example 10 | 0.25:1:0 |
| Example 11 | 0:1:0.25 |
| Comparative | 0:0:0 |
| Example 1 | |
| Comparative | 0:0:1 |
| Example 2 | |
| Comparative | 1:0:0 |
| Example 3 | |
| Comparative | 0:1:0 |
| Example 4 | |
| Comparative | 1:0:1 |
| Example 5 | |

### Experiment Example

The method for measuring various parameters involved in the present invention is as follows:

(1) Measurements on Performances of the Drilling Fluid

According to GB/T 16783.1-2006, measure various performance parameters of the drilling fluid in examples 1-11 and comparative examples 1-5 at 24±3. The results are shown in Table 2.

(2) Measurements on Blocking Ate and Permeability Recovery Rate

The reservoir protection performances are tested according to SYT 6540-2002 “Lab Testing Method of Drilling and Completion Fluids Damaging Oil Formation”, on a SH-1 high temperature and high pressure dynamic filter tester. Measure to obtain the size of the core, vacuumize and saturate using standard saline water for 48 h, measure in a forward direction oil phase permeability K₁ of the core (i.e., the initial core permeability in Table 3); and block the core in the dynamic filter tester using the prepared drilling fluid (the drilling fluid in examples 1-11 and comparative examples 1-5), after blocking is completed, eliminate mud cake at the blocking end, measure in a forward direction oil phase permeability K₂ of the core (i.e., the core permeability after blocking in Table 3), and calculate the blocking rate

$$BR = \frac{{K}_{1} - {K}_{2}}{{K}_{1}} \times 100 \% .$$

Then measure the backward direction oil phase permeability K₃ of the core after blocking, (i.e., the core permeability after flowback in Table 3), and calculate the permeability recovery rate

$$RR = \frac{{K}_{3}}{{K}_{1}} \times 100 \% .$$

The results are shown in Table 3.

TABLE 2

| | Apparent | Plastic | | |
|---|---|---|---|---|
| | viscosity AV/ | viscosity PV/ | Yield point | API filter |
| | (mPa · s) | (mPa · s) | YP/Pa | loss/ml |
| Example 1 | 49 | 30 | 19 | 4.5 |
| Example 2 | 51 | 33 | 20 | 4.6 |
| Example 3 | 51 | 31 | 20 | 4.7 |
| Example 4 | 47 | 31 | 16 | 4.8 |
| Example 5 | 50 | 32 | 18 | 4.8 |
| Example 6 | 52 | 35 | 17 | 4.4 |
| Example 7 | 50 | 32 | 18 | 5.2 |
| Example 8 | 50 | 33 | 17 | 5.8 |
| Example 9 | 52 | 33 | 19 | 5.6 |
| Example 10 | 46 | 30 | 16 | 6.0 |
| Example 11 | 52 | 33 | 19 | 4.8 |
| Comparative | 46 | 29 | 17 | 8.0 |
| Example 1 | | | | |
| Comparative | 52 | 36 | 18 | 4.0 |
| Example 2 | | | | |
| Comparative | 47 | 32 | 15 | 7.6 |
| Example 3 | | | | |
| Comparative | 46 | 29 | 17 | 4.8 |
| Example 4 | | | | |
| Comparative | 52 | 34 | 18 | 5.0 |
| Example 5 | | | | |

It can be seen from the data in Table 2 that, individually adding the synthetic fiber, elastic polymer particle and film-forming agent has few influence on the rheological property of the drilling fluid, and has a certain influence on the filter loss of the drilling fluid, wherein the capability of the film-forming agent to reduce the filter loss is stronger. When various components in the reservoir protecting agent composition of the present invention are used in a cooperated manner, the influence on the rheological property of the drilling fluid is still low while the filter loss of the drilling fluid can be obviously reduced, which is beneficial to protecting the reservoir.

TABLE 3

| | | Initial | Core | Core | | |
|---|---|---|---|---|---|---|
| | | core | permeability | permeability | | |
| | | permeability | K₂ after | K₃ after | | Permeability |
| Drilling | Width of | K₁/ | blocking/ | flowback/ | Blocking | recovery |
| fluid | cracks/μm | (10⁻³ μm²) | (10⁻³ μm²) | (10⁻³ μm²) | rate/% | rate/% |
| Example 1 | 50.2 | 132.5 | 0.66 | 130.1 | 99.5 | 98.2 |
| Example 2 | 48.5 | 107.4 | 3.34 | 105 | 96.9 | 97.8 |
| Example 3 | 52.1 | 137.9 | 4.62 | 132.1 | 96.6 | 95.8 |
| Example 4 | 51.9 | 138.3 | 4.10 | 135.9 | 97.0 | 98.3 |
| Example 5 | 50.7 | 123.8 | 1.36 | 120.0 | 98.9 | 96.9 |
| Example 6 | 50.2 | 129.4 | 2.85 | 125.8 | 97.8 | 97.2 |
| Example 7 | 51.3 | 130.5 | 12.40 | 119.1 | 90.5 | 91.3 |
| Example 8 | 51.8 | 125.7 | 16.00 | 112.9 | 87.3 | 89.8 |
| Example 9 | 53.2 | 131.2 | 16.80 | 114.8 | 87.2 | 87.5 |
| Example 10 | 52.4 | 127.5 | 14.79 | 117.3 | 88.4 | 92.0 |
| Example 11 | 51.7 | 122.6 | 11.28 | 114.9 | 90.8 | 93.7 |
| Comparative | 50.6 | 125.7 | 48.27 | 82.5 | 61.6 | 65.6 |
| Example 1 | | | | | | |
| Comparative | 49.8 | 112.7 | 33.27 | 85.7 | 70.5 | 76.0 |
| Example 2 | | | | | | |
| Comparative | 51.2 | 136.8 | 34.39 | 107.6 | 74.9 | 78.7 |
| Example 3 | | | | | | |
| Comparative | 49.5 | 115.4 | 15.54 | 102.8 | 86.5 | 89.1 |
| Example 4 | | | | | | |
| Comparative | 48.9 | 120.1 | 19.2 | 98.7 | 84.0 | 82.2 |
| Example 5 | | | | | | |

It can be seen from the data in Table 3 that, although using the three components in the reservoir protecting agent composition of the present invention separately or using with the synthetic fiber and film-forming agent in a cooperated manner has a certain function of protecting the reservoir, the reservoir protecting agent composition in the formula of the present invention has an obvious effect of protecting the reservoir, the blocking rate is more than 87%, preferably more than 96%, and the permeability recovery rate is more than 87%, preferably more than 95%, which indicates that various components in the reservoir protecting agent composition of the present invention have an obvious synergistic interaction effect among each other.

Specifically, upon comparison between the results in example 1 and example 7 in Table 3, it can be known that, when the mass ratio of the elastic polymer particle, the synthetic fiber and the film-forming agent is 1:(0.25-1):(0.25-1), it can further improve the effect of the drilling fluid to protect the reservoir.

Upon comparison between the results in example 1 and example 8 in Table 3, it can be known that, in the raw materials for preparing the intermediate product of the elastic polymer particle, based on 100 parts by weight of the raw materials, the acrylamide is present in 10-25 parts by weight, the cationic monomer is present in 2-5 parts by weight, the cross-linking agent is present in 0.01-0.05 parts by weight, the initiator is present in 0.02-0.05 parts by weight, and the toughening material is present in 8-15 parts by weight, it can further improve the effect of the drilling fluid to protect the reservoir.

Upon comparison between the results in example 1 and example 9 in Table 3, it can be known that, when based on 100 parts by weight of the elastic polymer particle, the intermediate product is present in 10-30 parts by weight, the base is present in 2-5 parts by weight, and the salt is present in 5-10 parts by weight, it can further improve the effect of the drilling fluid to protect the reservoir.

Upon comparison between the results in example 1 and examples 10 and 11 in Table 3, it can be known that, when the reservoir protecting agent composition contains the elastic polymer particle, the synthetic fiber and the film-forming agent at the same time, it can further improve the effect of the drilling fluid to protect the reservoir.

While some preferred embodiments of the present invention are described above, the present invention is not limited to the details in those embodiments. Those skilled in the art can make modifications and variations to the technical scheme of the present invention without departing from the spirit of the present invention. However, all these modifications and variations shall be deemed as falling into the protected scope of the present invention.

In addition, it should be appreciated that the technical features described in the above embodiments can be combined in any appropriate manner provided that there is no conflict among the technical features in the combination. To avoid unnecessary iteration, such possible combinations are not described here in the present invention.

Moreover, those of skill in the art will recognize that different embodiments of the present invention can be combined freely as long as the combinations don't substantially deviate from the general inventive concepts and spirit of the present invention. However, such combinations shall also be deemed as falling into the protected scope disclosed in the present invention.

1. A reservoir protecting agent composition, wherein the reservoir protecting agent composition contains an elastic polymer particle, and at least one of a synthetic fiber and a film-forming agent,
wherein the elastic polymer particle comprises an intermediate product, base, salt and water, and based on 100 parts by weight of the elastic polymer particle, the intermediate product is present in 5-40 parts by weight, the base is present in 1-10 parts by weight, and the salt is present in 1-12 parts by weight, and
wherein the intermediate product is prepared by raw materials comprising acrylamide, a cationic monomer, a cross-linking agent, an initiator, a toughening material and water, and based on 100 parts by weight of the raw materials, the acrylamide is present in 8-30 parts by weight, the cationic monomer is present in 1-10 parts by weight, the cross-linking agent is present in 0.01-0.5 parts by weight, the initiator is present in 0.01-0.1 parts by weight, and the toughening material is present in 5-25 parts by weight.

2. The reservoir protecting agent composition according to claim 1,
wherein the synthetic fiber ranges from 0.1 to 1.5 parts per 1 part of the elastic polymer particle composition, and the film-forming agent ranges from 0.1 to 1.5 parts per 1 part of the elastic polymer particle composition.

3. The reservoir protecting agent composition according to claim 2, wherein the synthetic fiber ranges from 0.25 to 1 parts per 1 part of the elastic polymer particle composition, and the film-forming agent ranges from 0.25 to 1 parts per 1 part of the elastic polymer particle composition.

4. The reservoir protecting agent composition according to claim 2, wherein the reservoir protecting agent composition contains the elastic polymer particle, the synthetic fiber and the film-forming agent, and synthetic fiber ranges from 0.1 to 1.5 parts and the film-forming agent ranges from 0.1 to 1.5 parts per 1 part of the elastic polymer particle composition.

5. The reservoir protecting agent composition according to claim 4, wherein the synthetic fiber ranges from 0.25 to 1 parts and the film-forming agent ranges from 0.25 to 1 parts per 1 part of the elastic polymer particle composition.

6. The reservoir protecting agent composition according to claim 1, wherein the elastic polymer particle, the synthetic fiber and the film-forming agent in the reservoir protecting agent composition are individually packaged, respectively.

7. The reservoir protecting agent composition according to claim 1, wherein the synthetic fiber is at least one of polyester fiber, polyamide fiber, polyacrylonitrile fiber, polyvinyl alcohol fiber, polyvinyl formal fiber and polyurethane elastic fiber; and the film-forming agent is a ultra-low permeable drilling fluid treating agent and/or zero osmosis drilling fluid treating agent.

8. The reservoir protecting agent composition according to claim 1, wherein based on 100 parts by weight of the raw materials for preparing the intermediate product, the acrylamide is present in 10-25 parts by weight, the cationic monomer is present in 2-5 parts by weight, the cross-linking agent is present in 0.01-0.05 parts by weight, the initiator is present in 0.02-0.05 parts by weight, and the toughening material is present in 8-15 parts by weight.

9. The reservoir protecting agent composition according to claim 1, wherein the cationic monomer is at least one of dimethyl diallyl ammonium halide, methacryloyloxyethyl trimethyl ammonium halide, acryloyloxyethyl trimethyl ammonium halide, alkyl dimethyl benzyl ammonium halide, and alkyl trimethyl ammonium halide;
the cross-linking agent is at least one of N,N′-methylene bis-acrylamide, divinyl benzene and glutaraldehyde;
the initiator is at least one of ammonium persulfate, potassium persulfate and sodium persulfate; and
the toughening material is starch and/or bentonite.

10. The reservoir protecting agent composition according to claim 9, wherein the alkyl in the alkyl dimethyl benzyl ammonium halide is C₈-C₂₀ alkyl, and the alkyl in the alkyl trimethyl ammonium halide is C₈-C₂₀ alkyl.

11. The reservoir protecting agent composition according to claim 1, wherein based on 100 parts by weight of the elastic polymer particle, the intermediate product is present in 10-30 parts by weight, the base is present in 2-5 parts by weight, and the salt is present in 5-10 parts by weight.

12. The reservoir protecting agent composition according to claim 1, wherein the elastic polymer particle further comprises bactericide, and based on 100 parts by weight of the elastic polymer particle, the bactericide is present in 0.03-2 parts by weight.

13. The reservoir protecting agent composition according to claim 12, wherein based on 100 parts by weight of the elastic polymer particle, the bactericide is present in 0.05-1 parts by weight.

14. The reservoir protecting agent composition according to claim 12, wherein the bactericide is at least one of alkyl trimethyl ammonium halide, alkyl halogenated pyridine and alkyl dimethyl benzyl ammonium halide.

15. The reservoir protecting agent composition according to claim 14, wherein the alkyl in the alkyl trimethyl ammonium halide is C₈-C₂₀ alkyl, the alkyl in the alkyl halogenated pyridine is C₈-C₂₀ alkyl, and the alkyl in the alkyl dimethyl benzyl ammonium halide is C₈-C₂₀ alkyl.

16. The reservoir protecting agent composition according to claim 1, wherein the base is at least one of sodium hydrate, potassium hydroxide, sodium carbonate, potassium carbonate, sodium bicarbonate and potassium bicarbonate; and
the salt is at least one of sodium chloride, potassium chloride, calcium chloride, sodium formate, potassium formate and cesium formate.

17. A drilling fluid, wherein the drilling fluid contains the reservoir protecting agent composition according to claim 1.

18. The drilling fluid according to claim 17, wherein based on 100 mL of drilling fluid, the reservoir protecting agent composition is 1-5 g.

19-20. (canceled)
